(19) United States
(12) Patent Application Publication
(10) Pub. No.: US 2019/0020559 A1
(43) Pub. Date: Jan. 17, 2019

(54) DISTRIBUTED HEALTH CHECK IN VIRTUALIZED COMPUTING ENVIRONMENTS

(71) Applicant: Nicira, Inc., Palo Alto, CA (US)

(72) Inventors: Zhihua CAO, Beijing (CN); Hailing XU, Beijing (CN)

(73) Assignee: Nicira, Inc., Palo Alto, CA (US)

(21) Appl. No.: 15/652,165

(22) Filed: Jul. 17, 2017

(51) Int. Cl. H04L 12/26; G06F 11/07; G06F 9/50; G06F 9/455

(52) U.S. Cl. CPC H04L 43/0811; G06F 11/0709; G06F 11/3003; G06F 9/45558; G06F 9/5083

(57) ABSTRACT

Example methods are provided for a host to implement distributed health check in a virtualized computing environment. The method may comprise monitoring health status information associated multiple virtualized computing instances supported by the host, the health status information indicating an availability of each of the multiple virtualized computing instances to handle traffic distributed by the computing system. The method may also comprise: in response to detecting, based on the health status information, a health status change associated with a particular virtualized computing instance from the multiple virtualized computing instances, generating a report message indicating the health status change associated with the particular virtualized computing instance; and sending, to the computing system, the report message to cause the computing system to adjust a traffic distribution to the particular virtualized computing instance.

### BACKGROUND

Unless otherwise indicated herein, the approaches described in this section are not admitted to be prior art by inclusion in this section.

Virtualization allows the abstraction and pooling of hardware resources to support virtual machines in a Software-Defined Data Center (SDDC). For example, through server virtualization, virtual machines running different operating systems may be supported by the same physical machine (e.g., referred to as a “host”). Each virtual machine is generally provisioned with virtual resources to run an operating system and applications. The virtual resources may include central processing unit (CPU) resources, memory resources, storage resources, network resources, etc.

In practice, virtual machines may be deployed in a virtualized computing environment to implement, for example, various nodes of a multi-node application. A load balancing system may be used to distribute traffic related to the application among the different virtual machines. However, a virtual machine may not be available or operational at all times. In this case, computing resources and time will be wasted if traffic is distributed to the virtual machine, thereby adversely affecting the performance of the application. To address this issue, health checks may be performed to assess the availability of the virtual machines.

### BRIEF DESCRIPTION OF DRAWINGS

FIG. 1 is a schematic diagram illustrating an example virtualized computing environment in which distributed health check may be performed;

FIG. 2 is a flowchart of an example process for a host to perform distributed health check in a virtualized computing environment;

FIG. 3 is a flowchart of an example detailed process for performing distributed health check using health check agents in a virtualized computing environment;

FIG. 4 is a schematic diagram illustrating an example implementation of distributed health check using health check agents according to the example in FIG. 3;

FIG. 5 is a flowchart of an example process for monitoring health check agents in a virtualized computing environment; and

FIG. 6 is a schematic diagram illustrating an example of monitoring health check agents according to the example in FIG. 3.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

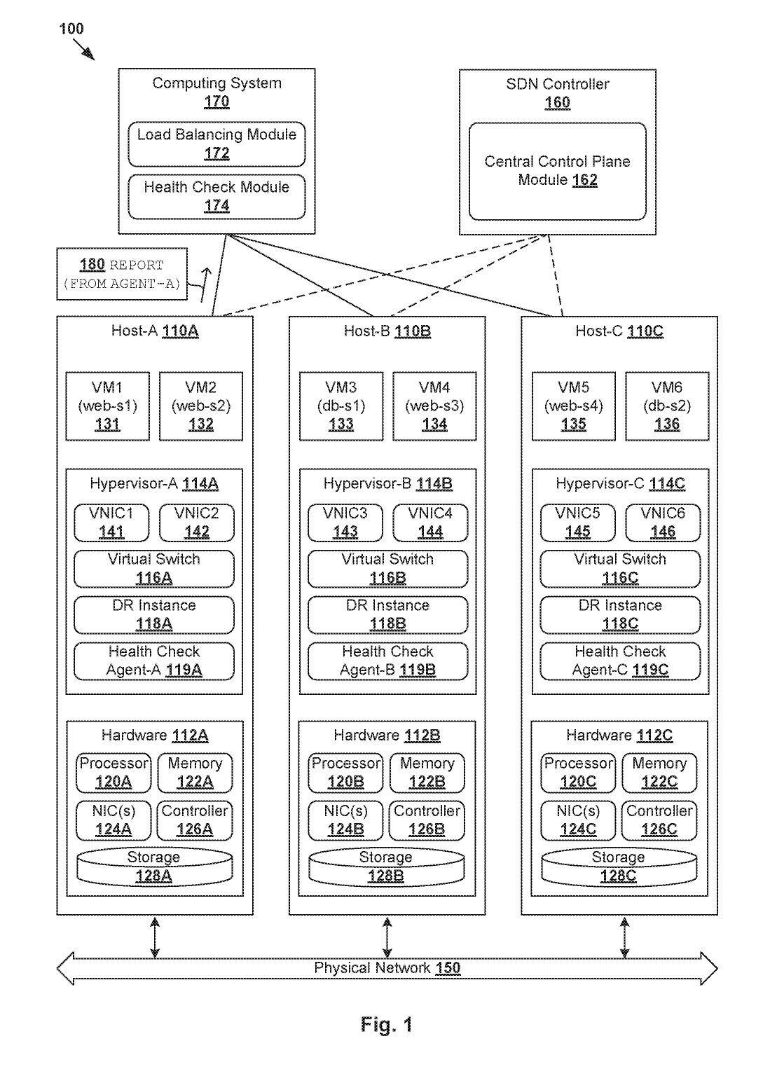

Challenges relating to health checks will now be explained in more detail using FIG. 1, which is a schematic diagram illustrating an example virtualized computing environment in which distributed health check may be performed. It should be understood that, depending on the desired implementation, virtualized computing environment 100 may include additional and/or alternative components than that shown in FIG. 1.

In the example in FIG. 1, virtualized computing environment 100 includes multiple hosts, such as host-A 110A, host-B 110B and host-C 110C that are inter-connected via physical network 150. Each host 110A/110B/110C includes suitable hardware 112A/112B/112C and virtualization software (e.g., hypervisor-A 114A, hypervisor-B 114B, hypervisor-C 114C) to support various virtual machines. For example, host-A 110A supports VM1 131 and VM2 132, host-B 110B supports VM3 133 and VM4 134, and host-C 110C supports VM5 135 and VM6 136. In practice, virtualized computing environment 100 may include any number of hosts (also known as a “host computers”, “host devices”, “physical servers”, “server systems”, etc.), where each host may be supporting tens or hundreds of virtual machines.

Although examples of the present disclosure refer to virtual machines, it should be understood that a “virtual machine” running on host 110A/110B/110C is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The virtual machines may also be complete computational environments, containing virtual equivalents of the hardware and software components of a physical computing system. The term “hypervisor” may refer generally to a software layer or component that supports the execution of multiple virtualized computing instances, including system-level software in guest virtual machines that supports namespace containers such as Docker, etc.

Hypervisor 114A/114B/114C maintains a mapping between underlying hardware 112A/112B/112C and virtual resources allocated to respective virtual machines 131-136. Hardware 112A/112B/112C includes suitable physical components, such as central processing unit(s) or processor(s) 120A/120B/120C; memory 122A/122B/122C; physical network interface controllers (NICs) 124A/124B/124C; and storage disk(s) 128A/128B/128C accessible via storage controller(s) 126A/126B/126C, etc. Virtual resources are allocated to each virtual machine to support a guest operating system (OS) and applications. Corresponding to hardware 112A/112B/112C, the virtual resources may include virtual CPU, virtual memory, virtual disk, virtual network interface controller (VNIC), etc. For example, virtual machines 131-136 are associated with respective VNICs 141-146.

Hypervisor 114A/114B/114C also implements virtual switch 116A/116B/116C and logical distributed router (DR) instance 118A/118B/118C to handle egress packets from, and ingress packets to, corresponding virtual machines 131-136. In practice, logical switches and logical distributed routers may be implemented in a distributed manner and can span multiple hosts to connect virtual machines 131-136. For example, logical switches that provide logical layer-2 connectivity may be implemented collectively by virtual switches 116A-C and represented internally using forwarding tables (not shown) at respective virtual switches 116A-C. Further, logical distributed routers that provide logical layer-3 connectivity may be implemented collectively by DR instances 118A-C and represented internally using routing tables (not shown) at respective DR instances 118A-C. As used herein, the term “packet” may refer generally to a group of bits that can be transported together from a source to a destination, such as segment, frame, message, datagram, etc. The term “layer 2” may refer generally to a Media Access Control (MAC) layer; and “layer 3” to a network or Internet Protocol (IP) layer in the Open System Interconnection (OSI) model, although the concepts described may be used with other networking models.

SDN controller 160 is a network management entity that facilitates implementation of software-defined (e.g., logical overlay) networks in virtualized computing environment 100. One example of an SDN controller is the NSX controller component of VMware NSX® (available from VMware, Inc.) that operates on a central control plane. SDN controller 160 may be a member of a controller cluster (not shown) that is configurable using an SDN manager (not shown) operating on a management plane. SDN controller 160 is also responsible for disseminating and collecting control information to and from hosts 110A-C, such as control information relating to logical overlay networks, logical switches, logical routers, etc. In practice, SDN controller 160 may be implemented using physical machine(s), virtual machine(s), or both.

Virtual machines 131-136 may be deployed as network nodes to implement a multi-node application whose functionality is distributed over the network nodes. In the example in FIG. 1, VM1 131 (“web-s1”), VM2 132 (“web-s2”), VM4 134 (“web-s3”) and VM5 135 (“web-s4”) form a pool of web servers, while VM3 133 (“db-s1”) and VM6 136 (“db-s2”) form a pool of database servers. The web servers may be responsible for processing incoming traffic (e.g., requests from web clients) to access web-based content. The database servers may be responsible for providing database services to web servers to query or manipulate data stored in a database. Application servers (not shown) may also be deployed to implement application logic, etc.

Computing system 170 is configured to distribute traffic (e.g., service requests) among virtual machines 131-136 that can handle a particular type of traffic. Computing system 170 may serve as a load balancer or proxy server to distribute incoming traffic from clients (not shown) among virtual machines 131-136, or to distribute traffic from one pool of servers to another. For example, the incoming traffic may be service requests that may be handled or processed by virtual machines 131-136. In practice, computing system 170 may be implemented using a standalone physical machine, or virtual machine(s) supported by a physical machine.

Computing system 170 may include any suitable modules, such as load balancing module 172 and health check module 174, etc. Load balancing module 172 is configured to perform load balancing to improve the distribution of traffic among virtual machines 131-136. Load balancing is also performed to optimize resource use, improve throughout, minimize response time, and avoid overburdening one virtual machine. Any suitable load balancing approach may be used by computing system 170, such as round robin, least connection, chained failover, source IP address hash, etc. To facilitate traffic distribution, health check module 174 is configured to perform health checks to determine whether virtual machines 131-136 are available to provide the requested service(s).

Conventionally, computing system 170 periodically sends health check request messages to detect the availability of virtual machines 131-136. For example in FIG. 1, computing system 170 may send six health check request messages to VM1 131, VM2 132, VM3 133, VM4 134, VM5 135 and VM6 136, respectively. If a health check response message is received from particular virtual machine (e.g., VM2 132), computing system 170 will consider the virtual machine to be available. Otherwise (i.e., no response message), the virtual machine is considered to be unavailable.

Although relatively straightforward to implement, the conventional approach creates a lot of processing burden on computing system 170 because it is configured to generate and send health check request messages to virtual machines 131-136 periodically (e.g., every hour). Additionally, computing resources are required to receive and parse each and every response message from virtual machines 131-136. This problem is exacerbated when the computing system 170 performs traffic distribution for hundreds or thousands of virtual machines supported by various hosts. The large number of request and response messages also consumes a lot of network resources, which may adversely affect the performance of other network resource consumers in virtualized computing environment 100.

Distributed Health Check

According to examples of the present disclosure, health checks may be implemented more efficiently in a distributed manner. Instead of necessitating computing system 170 to generate and send health check request messages to virtual machines 131-136 periodically, hosts 110A-C may report any health status change associated with virtual machines 131-136 to computing system 170. This reduces the processing burden on computing system 170, as well as improving the overall network resource utilization in virtualized computing environment 100.

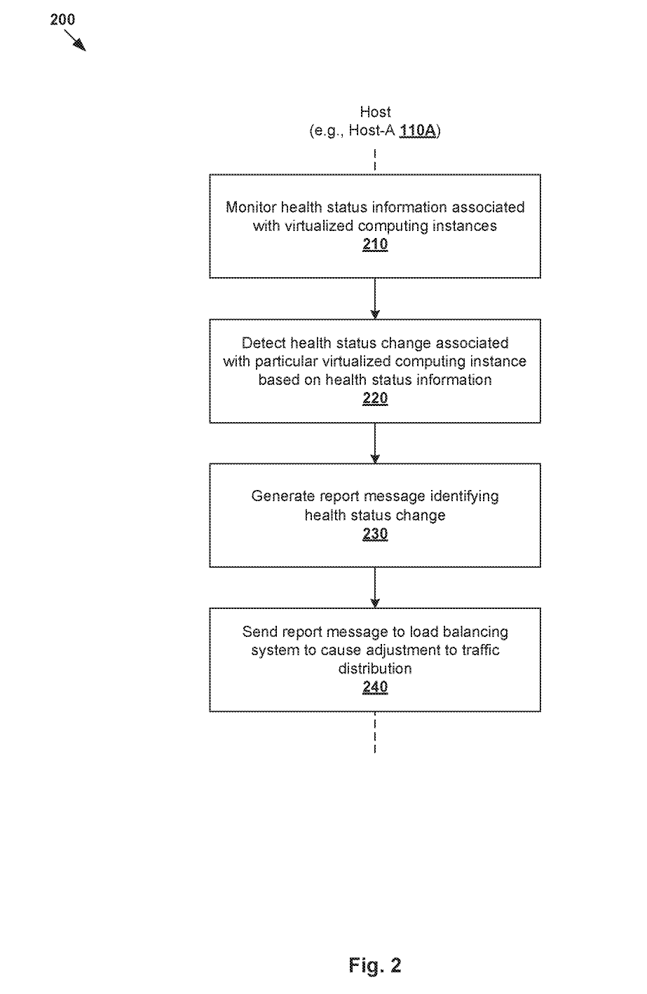

In more detail, FIG. 2 is a flowchart of example process 200 for a host to perform distributed health check in virtualized computing environment 100. Example process 200 may include one or more operations, functions, or actions illustrated by one or more blocks, such as 210 to 240. The various blocks may be combined into fewer blocks, divided into additional blocks, and/or eliminated depending on the desired implementation. In practice, example process 200 may be implemented by any suitable host 110A/110B/110C, such as using health check agent 119A/119B/119C supported by hypervisor 114A/114B/114C, etc. In the following, host-A 110A will be used as an example “host,” and VM1 131 and VM2 132 as an example “multiple virtualized computing instances.”

At 210 in FIG. 2, host-A 110A monitors health status information associated VM1 131 and VM2 132 (i.e., multiple virtual machines) supported by host-A 110A. The health status information indicates an availability of each of VM1 131 and VM2 132 to handle traffic distributed by computing system 170. At 220, 230 and 240, in response to host-A 110A detecting a health status change associated with VM1 131 based on the health status information, host-A 110A generates and sends a report message indicating the health status change (see 180 in FIG. 1). The report message may be sent to cause computing system 170 to adjust a traffic distribution to VM1 131.

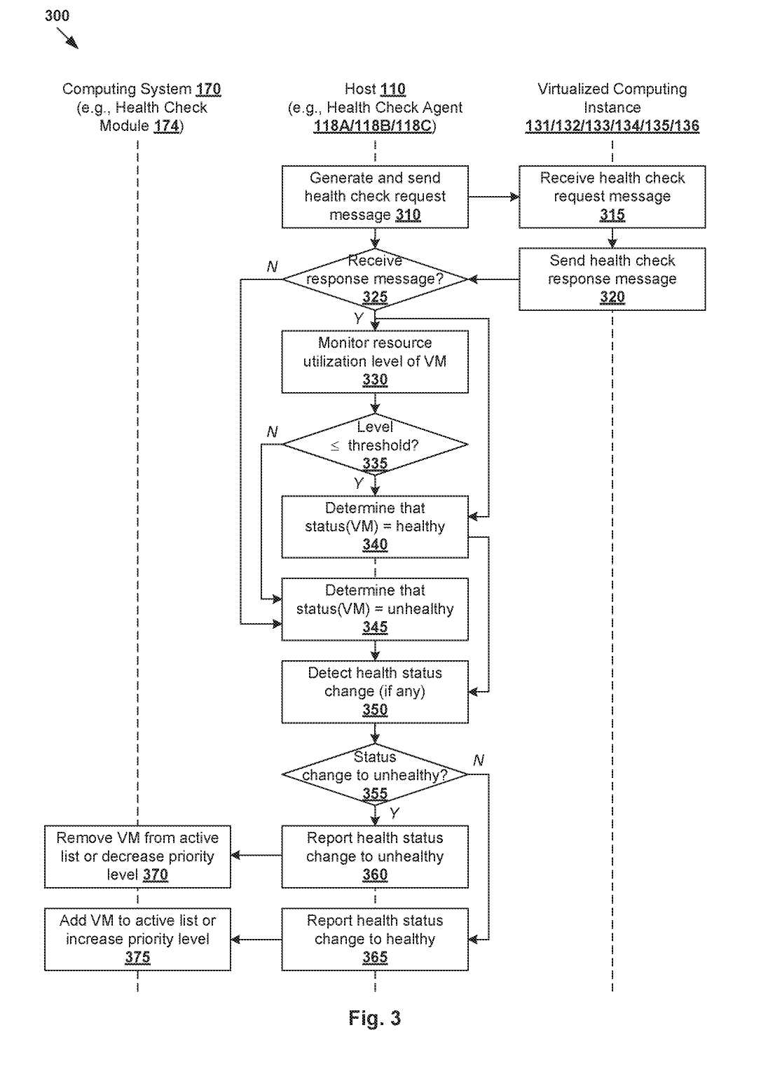

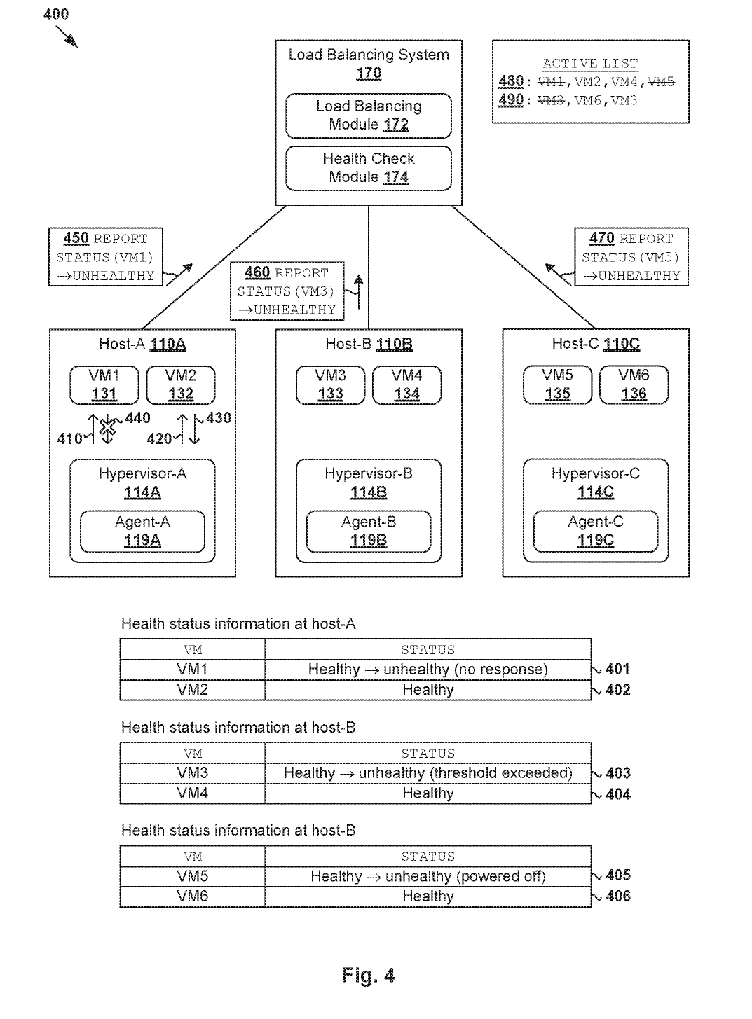

As will be described further using FIG. 3 and FIG. 4, monitoring the health status information at block 210 may involve health check agent 119A checking the availability of VM1 131 and VM2 132 using request and response messages. In another example, the health status information may be monitored based on a resource utilization level of virtual machine 131/132, a power state of virtual machine 131/132, etc. The health status change detected at block 220 may be from a healthy status (i.e., available) to unhealthy status (i.e., unavailable), or vice versa.

According to examples of the present disclosure, it is not necessary for virtual machines 131-136 to periodically respond to health check request messages sent by computing system 170. Instead, report messages are only generated and sent when a health status change (e.g., healthy to unhealthy) is detected at host 110A/110B/110C. As will be described further below, the task of health checks may be offloaded from health check module 174 at computing system 170 to health check agent 119A/119B/119C at host 110A/110B/110C. This also reduces the amount of traffic relating to health checks between computing system 170 and host 110A/110B/110C in virtualized computing environment 100. In the following, various examples will be described using FIG. 3 to FIG. 6.

Health Status Change

FIG. 3 is a flowchart of example detailed process 300 for distributed health check using health check agents 119A-C in virtualized computing environment 100. Example process 300 may include one or more operations, functions, or actions illustrated by one or more blocks, such as 310 to 375. The various blocks may be combined into fewer blocks, divided into additional blocks, and/or eliminated depending on the desired implementation.

Example process 300 will be explained using FIG. 4, which is a schematic diagram illustrating example implementation 400 of distributed health check using health check agents 119A-C in virtualized computing environment 100 according to the example in FIG. 3. In practice, blocks 310 and 325-365 may be implemented by host 110A/110B/110C, such as using health check agent 119A/119B/119C. Blocks 370-375 may be implemented by computing system 170, such as using load balancing module 172 and health check module 174.

At 310 to 335 in FIG. 3 (related to block 210 in FIG. 2), host 110A/110B/110C monitors health status information associated with various virtual machines. For example in FIG. 4, first health check agent 119A (“agent-A”) is responsible for monitoring the health status information associated with VM1 131 and VM2 132 at host-A 110A, second health check agent 119B (“agent-B”) responsible for VM3 133 and VM4 134 at host-B 110B, and third health check agent 119C (“agent-C”) responsible for VM5 135 and VM6 136 at host-C 110C.

In one example, at 310 in FIG. 3, the health status information of a particular virtual machine may be monitored by sending a request message to check its availability. For example in FIG. 4, agent-A 119A generates and sends a first health check request message (see 410) to VM1 131, and a second health check request message (see 420) to VM2 132. At 315 and 320, if virtual machine 131/132 is available, it will respond with a health check response message. Otherwise, no response message will be sent to agent-A 119A.

At 325 and 340 in FIG. 3, in response to receiving a response message (see 430) from VM2 132, it is determined that status(VM2)=healthy (see 402). Otherwise, at 345 in FIG. 3, since no response message is received from VM1 131 (see 440), it is determined that status(VM1)=unhealthy (see 401). In practice, any suitable protocol may be used to generate the request and response, such as HyperText Transfer Protocol (HTTP), Simple Network Management Protocol (SNMP), Internet Control Message Protocol (ICMP), etc.

Alternatively or additionally, at 330 in FIG. 3, the health status of a virtual machine may be monitored based on its resource utilization level. At 325 and 330, if the resource utilization level does not exceed a predetermined threshold, the virtual machine is determined to be healthy. Otherwise, at 345, the virtual machine is determined to be unhealthy. In practice, the “resource utilization level” at blocks 330-335 may be associated with CPU resource utilization, memory resource utilization, storage resource utilization, network resource utilization, or a combination thereof, etc.

For example in FIG. 4, in response to determination that a CPU resource utilization level of VM3 133 at host-B 110B exceeds a predetermined threshold (e.g., 80%), agent-B 119B determines that status(VM3)=unhealthy (see 403). In response to determination that a CPU resource utilization level of VM4 134 is less than the predetermined threshold, agent-B 119B determines that status(VM4)=healthy (see 404). A weighted combination of resource utilization levels may also be used, or multiple levels compared against respective thresholds.

It should be understood that the health status of a virtual machine may also be monitored using any alternative or additional criterion or criteria, such as a power state associated with each virtual machine (e.g., powered on, powered off or suspended). For example in FIG. 4, in response to detection that VM5 135 is powered off, agent-C 119C may determine that status(VM5)=unhealthy (see 405) because it is not able to service any request from computing system 170. This same unhealthy status also applies when VM5 135 is suspended to temporarily pause or disable all of its operations. VM5 135 may be determined to be healthy when it is powered on again, or have its operations resumed from suspension.

At 350 in FIG. 3, host 110A/110B/110C detects whether there has been a health status change based on the health status information. At 355, 360 and 365, if there has been a health status change, a report message is generated and sent to computing system 170 to cause computing system 170 adjust its traffic distribution accordingly. For example, at host-A 110A in FIG. 4, in response to detection that status(VM1) has changed from healthy to unhealthy (see 401), agent-A 119A generates and sends a first report message (see 450) to indicate the unhealthy status of VM1 131. The first report message may also indicate the reason of the health status change, such as no response message has been received from VM1 131.

Similarly, at host-B 110B, in response to detection that status(VM3) has changed from healthy to unhealthy (see 403), agent-B 119B generates and sends a second report message (see 460) accordingly. The second report message may indicate the unhealthy status because the CPU resource utilization level of VM3 133 has exceeded the threshold. Further, at host-C 110C, agent-C 119C generates and sends a third report message (see 470) to report that the health status change associated with VM5 135. Each report message may also include any other suitable information, such as the time when the health status change is detected, etc. To further improve efficiency and reduce the amount of traffic between host 110A/110B/110C and computing system 170, a single report message may also indicate the health status change of multiple virtual machines, such as when both VM5 135 and VM6 136 change from healthy to unhealthy, etc.

At 370 in FIG. 3, based on the first and third report messages (see 450 and 460) from respective host-A 110A and host-C 110C, health check module 174 at computing system 170 removes VM1 131 and VM5 135 from an active list of web servers (see 480) accessible by load balancing module 174. Based on the second report message (see 470) from host-B 110B, VM3 133 may be removed from an active list of database servers (see 490) accessible by load balancing module 174. Alternatively, instead of removing VM1 131, VM3 133 and VM5 135 from the active list, their priority level (or weighting) on the active list may also be reduced. This causes load balancing module 172 to stop or reduce traffic distribution to those virtual machines.

Although not shown in FIG. 4, agent-A 119A may continue monitor the health status of VM1 131. In response to detecting a health status change from an unhealthy status to a healthy status, agent-A 119A may generate a further report message to computing system 170. The report message is then sent to cause computing system 170 to re-add VM1 131 to the active list (see 480), or increase its priority level on the list. In other words, when VM1 131 is healthy again, it will be marked up to increase the amount of traffic distributed to VM3 133 by load balancing module 172. See also corresponding blocks 365 and 375 in FIG. 3.

Heartbeat Mechanism

In practice, health check agent 119A/119B/119C may fail due to various reasons, such as software failure (e.g., agent or hypervisor crashing), hardware failure, etc. In this case, health check agent 119A/119B/119C will not be able to report any health status change to computing system 170, which assumes that the associated virtual machines are healthy and available. To resolve this issue, a heartbeat mechanism may be used to assess the status of health check agent 119A/119B/119C using SDN controller 160 for example.

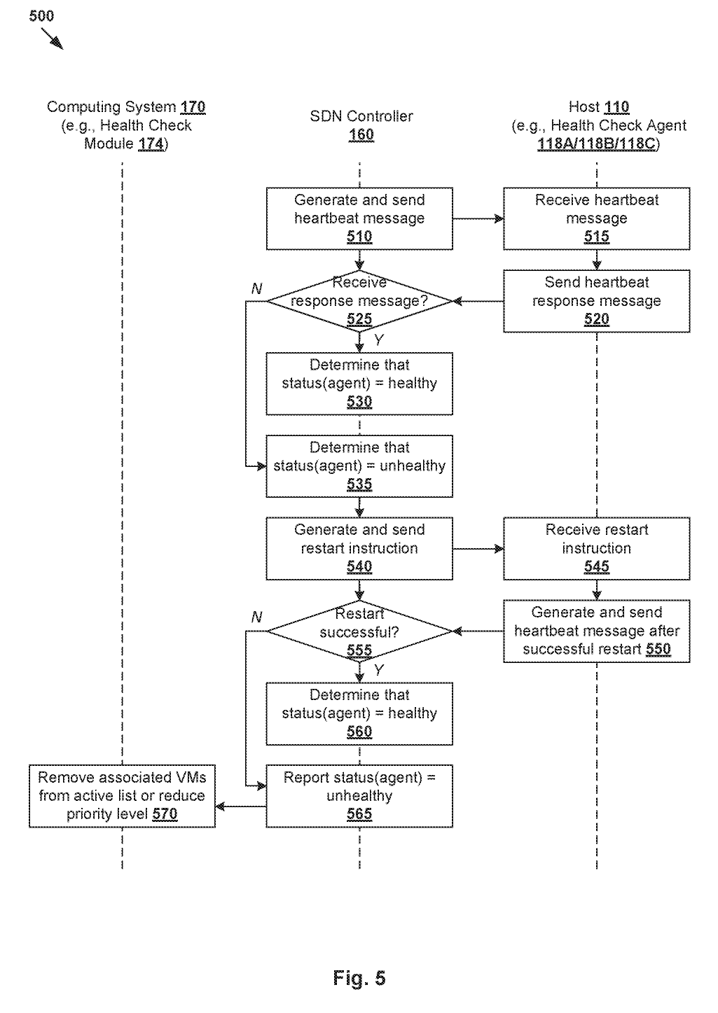

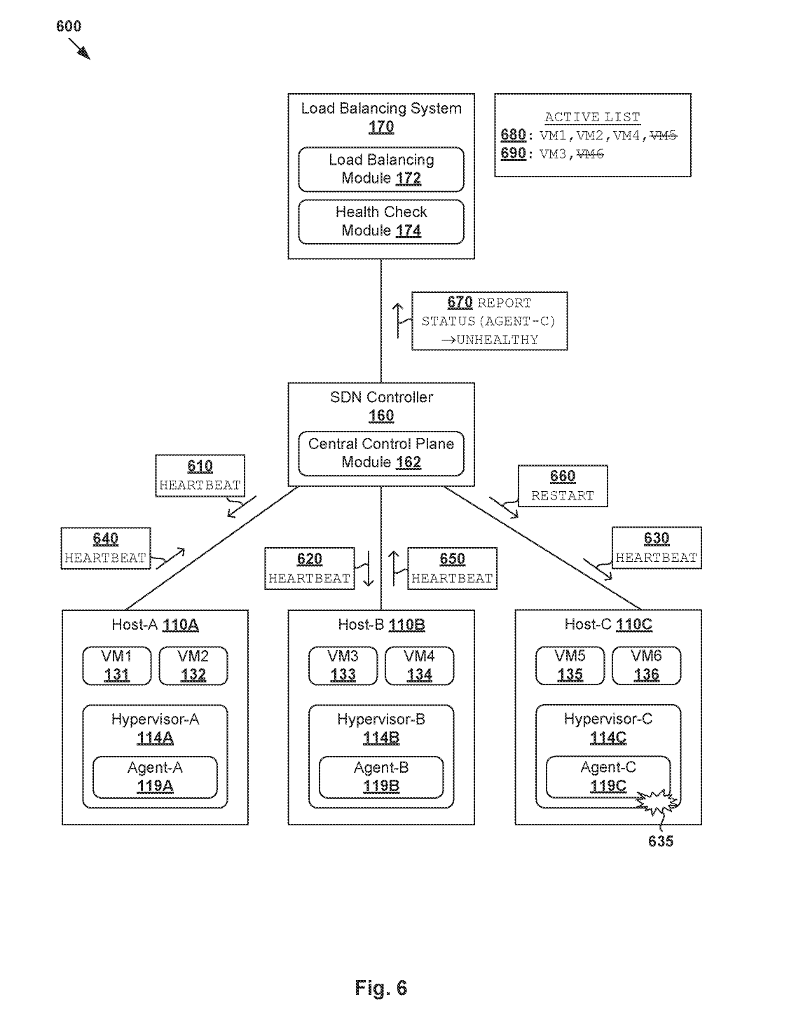

In more detail, FIG. 5 is a flowchart of example process 500 for monitoring health check agents 119A-C in virtualized computing environment 100. Example process 500 may include one or more operations, functions, or actions illustrated by one or more blocks, such as 510 to 570. The various blocks may be combined into fewer blocks, divided into additional blocks, and/or eliminated depending on the desired implementation. Blocks 510, 525-565 may be implemented by SDN controller 160, such as using central control plane module 162. Blocks 515-520 and 545-550 may be implemented by host 110A/110B/110C, such as using health check agent 119A/119B/119C. Blocks 570 may be implemented by computing system 170, such as using health check module 174, etc. Example process 500 will be explained using FIG. 6, which is a schematic diagram illustrating example 600 of monitoring health check agents 119A-C according to the example in FIG. 5

At 510 in FIG. 5, SDN controller 160 generates and sends a heartbeat message to each health check agent 119A/119B/119C periodically, such as every one hour, etc. The heartbeat message is to check whether health check agent 119A/119B/119C is alive. At 515 and 520, if health check agent 119A/119B/119C is alive, a heartbeat message is generated and sent to SDN controller 160. At 525 and 530, in response to receiving a heartbeat message, SDN controller 160 determines that health check agent 119A/119B/119C is healthy (i.e., alive). Otherwise, at 535, health check agent 119A/119B/119C is determined to be unhealthy (i.e., not alive).

In the example in FIG. 6, three heartbeat messages (see 610, 620 and 630) are sent to health check agents 119A-C respectively. In response, agent-A 119A and agent-B 119B each generate and send a heartbeat message (see 640 and 650) to SDN controller 160, which consider both agents to be healthy. However, since there is a failure at host-C 110C (see 635), no heartbeat message is sent from agent-C 119C to SDN controller 160.

At 540 and 545 in FIG. 5, SDN controller 160 generates and sends a restart instruction (see 660) to hypervisor-C 114C to restart agent-C 119C. At 550, 555 and 560, if the restart is successful, agent-C 119C generates and sends a heartbeat message to SDN controller 160. This causes SDN controller 160 to determine that agent-C 119C is healthy. Otherwise, at 565, if no heartbeat message is received within a predetermined time, SDN controller 160 generates and sends a report message (see 670) to health check module 174. The report message may also identify VM5 135 and VM6 136 being monitored by agent-C 119C at host-C 110C.

At 570 in FIG. 5, in response to receiving the report message from SDN controller 160, health check module 174 learns that agent-C 119C at host-C 110C is unhealthy (i.e., not alive). At 565 and 570, health check module 174 also determines that both VM5 135 and VM6 136 are unhealthy and adjust traffic distribution to them accordingly. In the example in FIG. 6, health check module 174 updates the active list of web servers is updated by removing VM5 135, or reducing its priority level (see 680). Similarly, the active list for database servers is updated by removing VM6 136, or reducing its priority level (see 690).

In practice, the heartbeat mechanism may also be initiated by health check agent 119A/119B/119C, which sends a heartbeat message to SDN controller 160 periodically. If no heartbeat message is received within a predetermined time, SDN controller 160 may send a heartbeat message to health check agent 119A/119B/119C to check whether it is alive. If not, a restart instruction is sent to hypervisor 114A/114B/114C. SDN controller 160 may be used to configure health check module 174 and health check agent 119A/119B/119C to perform the examples described using FIG. 1 to FIG. 6.

In another example, the heartbeat mechanism may be implemented between computing system 170 and health check agent 119A/119B/119C. In this case, blocks 510, 525-565 may be implemented by health check module 174 at computing system 170, instead of SDN controller 160. If health check module 174 does not have the privilege to instruct hypervisor 114A/114B/114C to restart health check agent 119A/119B/119C, the restart instruction may be generated and sent using SDN controller 160.

Although explained using virtual machines 131-136, it should be understood the examples in FIG. 1 to FIG. 6 may be applied to other “virtualized computing instances,” such as containers, etc. For example, VM1 131 may support a container that implements the functionality of a web server. In this case, a guest OS of VM1 131 and/or hypervisor-A 114A may perform one or more of blocks 310, 325-365 in FIG. 3. For example, the guest OS may generate and send health check requests to the container and/or monitor a resource utilization level of the container. A particular guest OS may monitor the health status of multiple containers that each execute an application. Alternatively or additionally, health check agent 118A may communicate with the guest OS to detect a health status change associated with the container. Similarly, to implement the heartbeat mechanism, the guest OS and/or health check agent 118A may perform blocks 515-520 and 545-550 in FIG. 5.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 6. For example, a computer system may be deployed in virtualized computing environment 100 to perform the functionality of a network management entity (e.g., SDN controller 160), host 110A/110B/110C, computing system 170, etc.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a host to implement distributed health check in a virtualized computing environment that includes the host and a computing system, wherein the method comprises:
monitoring health status information associated multiple virtualized computing instances supported by the host, wherein the health status information indicates an availability of each of the multiple virtualized computing instances to handle traffic distributed by the computing system; and
in response to detecting, based on the health status information, a health status change associated with a particular virtualized computing instance from the multiple virtualized computing instances,
generating a report message indicating the health status change associated with the particular virtualized computing instance; and
sending, to the computing system, the report message to cause the computing system to adjust a traffic distribution to the particular virtualized computing instance.

2. The method of claim 1, wherein monitoring the health status information comprises:
generating and sending multiple request messages to the respective multiple virtualized computing instances; and
in response to determination that a response message is received from the particular virtualized computing instance within a predetermined time, determining that the particular virtualized computing instance is associated with a healthy status, but otherwise, determining that the particular virtualized computing instance is associated with an unhealthy status.

3. The method of claim 1, wherein monitoring the health status information comprises:
monitoring a resource utilization level associated with the particular virtualized computing instance; and
in response to determination that the resource utilization level exceeds a predetermined threshold, determining that the particular virtualized computing instance is associated with an unhealthy status, but otherwise, determining that the particular virtualized computing instance is associated with a unhealthy status.

4. The method of claim 1, wherein monitoring the health status information comprises:
monitoring a power state associated with the particular virtualized computing instance; and
in response to determination that the power state is on, determining that the particular virtualized computing instance is associated with a healthy status, but otherwise, determining that the particular virtualized computing instance is associated with an unhealthy status.

5. The method of claim 1, wherein generating and sending the report message comprises:
in response detecting the health status change from a healthy status to an unhealthy status, indicating the unhealthy status in the report message; and
sending the report message to cause the computing system to remove the particular virtualized computing instance from an active list, or reduce its priority level on the active list.

6. The method of claim 4, wherein generating and sending the report message comprises:
in response detecting the health status change from the unhealthy status to the healthy status, indicating the healthy status in the report message; and
sending the report message to cause the computing system to add the particular virtualized computing instance to the active list, or increase its priority level on the active list.

7. The method of claim 1, wherein the method further comprises:
receiving, by a health check agent supported by the host, a heartbeat request message from the computing system or a network management entity; and
generating and sending, by the health check agent, a heartbeat response message to indicate that the health check agent is alive, wherein not sending the heartbeat response message causes the computing system to reduce the distribution of traffic to the multiple virtualized computing instances.

8. A non-transitory computer-readable storage medium that includes a set of instructions which, in response to execution by a processor of a host, cause the processor to perform a method of distributed health check in a virtualized computing environment that includes the host and a computing system, wherein the method comprises:
monitoring health status information associated multiple virtualized computing instances supported by the host, wherein the health status information indicates an availability of each of the multiple virtualized computing instances to handle traffic distributed by the computing system; and
in response to detecting, based on the health status information, a health status change associated with a particular virtualized computing instance from the multiple virtualized computing instances,
generating a report message indicating the health status change associated with the particular virtualized computing instance; and
sending, to the computing system, the report message to cause the computing system to adjust a traffic distribution to the particular virtualized computing instance.

9. The non-transitory computer-readable storage medium of claim 8, wherein monitoring the health status information comprises:
generating and sending multiple request messages to the respective multiple virtualized computing instances; and
in response to determination that a response message is received from the particular virtualized computing instance within a predetermined time, determining that the particular virtualized computing instance is associated with a healthy status, but otherwise, determining that the particular virtualized computing instance is associated with an unhealthy status.

10. The non-transitory computer-readable storage medium of claim 8, wherein monitoring the health status information comprises:
monitoring a resource utilization level associated with the particular virtualized computing instance; and
in response to determination that the resource utilization level exceeds a predetermined threshold, determining that the particular virtualized computing instance is associated with an unhealthy status, but otherwise, determining that the particular virtualized computing instance is associated with a unhealthy status.

11. The non-transitory computer-readable storage medium of claim 8, wherein monitoring the health status information comprises:
monitoring a power state associated with the particular virtualized computing instance; and
in response to determination that the power state is on, determining that the particular virtualized computing instance is associated with a healthy status, but otherwise, determining that the particular virtualized computing instance is associated with an unhealthy status.

12. The non-transitory computer-readable storage medium of claim 8, wherein generating and sending the report message comprises:
in response detecting the health status change from a healthy status to an unhealthy status, indicating the unhealthy status in the report message; and
sending the report message to cause the computing system to remove the particular virtualized computing instance from an active list, or reduce its priority level on the active list.

13. The non-transitory computer-readable storage medium of claim 12, wherein generating and sending the report message comprises:
in response detecting the health status change from the unhealthy status to the healthy status, indicating the healthy status in the report message; and
sending the report message to cause the computing system to add the particular virtualized computing instance to the active list, or increase its priority level on the active list.

14. The non-transitory computer-readable storage medium of claim 8, wherein the method further comprises:
receiving, by a health check agent supported by the host, a heartbeat request message from the computing system or a network management entity; and
generating and sending, by the health check agent, a heartbeat response message to indicate that the health check agent is alive, wherein not sending the heartbeat response message causes the computing system to reduce the distribution of traffic to the multiple virtualized computing instances.

15. A host configured to implement distributed health check in a virtualized computing environment that includes the host and a computing system, wherein the host comprises:
a processor; and
a non-transitory computer-readable medium having stored thereon instructions that, when executed by the processor, cause the processor to:
monitor health status information associated multiple virtualized computing instances supported by the host, wherein the health status information indicates an availability of each of the multiple virtualized computing instances to handle traffic distributed by the computing system; and
in response to detecting, based on the health status information, a health status change associated with a particular virtualized computing instance from the multiple virtualized computing instances,
generate a report message indicating the health status change associated with the particular virtualized computing instance; and
send, to the computing system, the report message to cause the computing system to adjust a traffic distribution to the particular virtualized computing instance.

16. The host of claim 15, wherein the instructions for monitoring the health status information cause the processor to:
generate and send multiple request messages to the respective multiple virtualized computing instances; and
in response to determination that a response message is received from the particular virtualized computing instance within a predetermined time, determine that the particular virtualized computing instance is associated with a healthy status, but otherwise, determine that the particular virtualized computing instance is associated with an unhealthy status.

17. The host of claim 15, wherein the instructions for monitoring the health status information cause the processor to:
monitor a resource utilization level associated with the particular virtualized computing instance; and
in response to determination that the resource utilization level exceeds a predetermined threshold, determine that the particular virtualized computing instance is associated with an unhealthy status, but otherwise, determine that the particular virtualized computing instance is associated with a unhealthy status.

18. The host of claim 15, wherein the instructions for monitoring the health status information cause the processor to:
monitor a power state associated with the particular virtualized computing instance; and
in response to determination that the power state is on, determine that the particular virtualized computing instance is associated with a healthy status, but otherwise, determine that the particular virtualized computing instance is associated with an unhealthy status.

19. The host of claim 15, wherein the instructions for generating and sending the report message cause the processor to:
in response detecting the health status change from a healthy status to an unhealthy status, indicate the unhealthy status in the report message; and
send the report message to cause the computing system to remove the particular virtualized computing instance from an active list, or reduce its priority level on the active list.

20. The host of claim 19, wherein the instructions for generating and sending the report message cause the processor to:
in response detecting the health status change from the unhealthy status to the healthy status, indicate the healthy status in the report message; and
send the report message to cause the computing system to add the particular virtualized computing instance to the active list, or increase its priority level on the active list.

21. The host of claim 15, wherein the instructions further cause the processor to:
receive, by a health check agent supported by the host, a heartbeat request message from the computing system or a network management entity; and
generate and send, by the health check agent, a heartbeat response message to indicate that the health check agent is alive, wherein not sending the heartbeat response message causes the computing system to reduce the distribution of traffic to the multiple virtualized computing instances.
